(19) United States
(12) Patent Application Publication
(10) Pub. No.: US 2014/0283793 A1
(43) Pub. Date: Sep. 25, 2014

(54) METHOD AND DEVICE FOR CONTROLLING AN INJECTION VALVE

(71) Applicants: Oezguer Tuerker, Gerlingen (DE); Christian Szonn, Stuttgard (DE)

(72) Inventors: Oezguer Tuerker, Gerlingen (DE); Christian Szonn, Stuttgard (DE)

(21) Appl. No.: 14/360,227

(22) PCT Filed: Nov. 12, 2012
(86) PCT No.: PCT/EP2012/072368

§ 371 Date: May 22, 2014

(30) Foreign Application Priority Data
Nov. 23, 2011 (DE) 10 2011 086 957.3

(51) Int. Cl. F02D 41/30

(52) U.S. Cl. CPC F02D 41/30
USPC 123/490

(57) ABSTRACT

An activation signal for activating a solenoid valve, in particular, a fuel injector of an internal combustion engine, has a pickup phase and a holding phase. The pickup phase has a comparatively high current and a maximally permissible duration, and the holding phase has a comparatively low current and a minimally permissible duration (MHD). The minimally permissible duration (MHD) of the holding phase is at least periodically dependent on a nominal total duration (GAD) of the activation signal.

### FIELD OF THE INVENTION

The present invention relates to a method for activating a solenoid valve. The present invention also relates to a computer program, as well as to a control and/or regulating device.

### BACKGROUND INFORMATION

Modern internal combustion engines are frequently equipped with a common-rail fuel system where injectors inject the fuel directly into combustion chambers of the internal combustion engine. Typical injectors have an electromagnetic actuator that acts via an armature on a valve element. A control device of the internal combustion engine controls the fuel quantity by adjusting the fuel pressure in the common rail and by adjusting the duration of the electrical activation of the electromagnetic actuator of the injector. This activation is made up of a plurality of energization phases, each having different current intensities and durations. A first energization phase is typically what is generally referred to as a “pickup phase,” and the second energization phase what is generally referred to as a “holding phase.” The pickup phase has a higher current level than the holding phase and is primarily used for inducing a most rapid possible opening of the injector. The holding phase has a lower current level than the pickup phase and is primarily used for holding the injector open using as little energy as possible.

A maximally permissible duration is applied for the pickup phase; a minimally permissible duration is applied for the holding current phase. If the entire activation duration is shorter than the sum of the maximum duration of the pickup phase and the minimum duration of the holding current phase, then the duration of the pickup phase is modified, while the duration of the holding phase constantly retains the applied minimum value thereof If the entire activation duration is longer than the sum of the maximally permissible duration of the pickup phase and the minimally permissible duration of the holding phase, the duration of the holding phase is then modified, while the duration of the pickup phase constantly retains the applied maximum value thereof In this activation strategy, most notably in the context of short activation durations, a certain waviness is sometimes observed in the relation between the activation duration and the injection quantity.

### SUMMARY

It is, therefore, an object of the present invention to simplify the applicability of the relation (the characteristics map or the characteristic curve) that links the injection quantity to the activation signal. Such quantity correction functions are also to be simplified or perhaps even entirely eliminated.

The present invention makes it possible to reduce the waviness in the relation between the injection quantity and the activation signal that is present most notably in the context of short activation durations, thus, to linearize this relation at least to some extent. This facilitates the application of the appropriate characteristic map or of the appropriate characteristic curve and results in cost savings, reduced computational outlay, etc. At the heart of the present invention is, in fact, the principle of specifying a minimally permissible duration of the holding phase, but of making this minimally permissible duration variable, namely variable as a function of the nominal total duration of the activation signal.

The minimally permissible duration of the holding phase should be longer in the case of a comparatively short nominal total duration than in the case of a comparatively long nominal total duration. As a result, when a comparatively short nominal total duration is desired, the pickup phase having a comparatively high current level is shortened due to the longer minimal permissible duration of the holding phase. This results in an earlier drop in the solenoid force and, thus, in an earlier closing of the solenoid valve.

It is also possible, however, that the minimally permissible duration of the holding phase is shorter in the case of a comparatively short nominal total duration than in the case of a comparatively long nominal total duration. The waviness in the relation between the injection quantity and the activation signal is hereby actually not reduced; rather completely new adaptation possibilities are devised that make possible an optimal fuel injection characterized by low consumption and low emissions.

The method is advantageously used only when the nominal total duration of the activation signal is at least also composed of the minimally permissible duration of the holding phase. Only in such operating situations does the variability of the minimally permissible duration of the holding phase have any effect at all. If the variability is at all realized in such operating situations, computational resources are altogether economized.

An especially simple form of the dependence between the minimally permissible duration of the holding phase and the nominal total duration of the activation signal is a linear dependence that already leads to an effective evening out of the dependence of the fluid quantity, which is terminated by the solenoid valve, on the activation duration. Fundamentally conceivable and likewise within the scope of the present invention, however, is any other type of dependence, such as exponential, graduated or the like, for example.

### BRIEF DESCRIPTION OF THE DRAWINGS

FIG. 1 is a schematic representation of an internal combustion engine of a motor vehicle having a plurality of fuel injectors.

FIG. 2 shows a diagram in which a control current of an electromagnetic actuator of one of the fuel injectors of FIG. 1 is plotted over time.

FIG. 3 is a representation similar to that of FIG. 2 for various activation durations.

FIG. 4 is a representation similar to that of FIG. 2 having a longer minimal permissible duration of a holding phase and a shorter minimal permissible duration of a holding phase; a solenoid force and an armature stroke being additionally plotted.

FIG. 5 shows a diagram in which a duration of the holding phase and an injection quantity are plotted over the activation duration for a conventional method and for a method according to the present invention for activating the fuel injector of FIG. 1.

### DETAILED DESCRIPTION

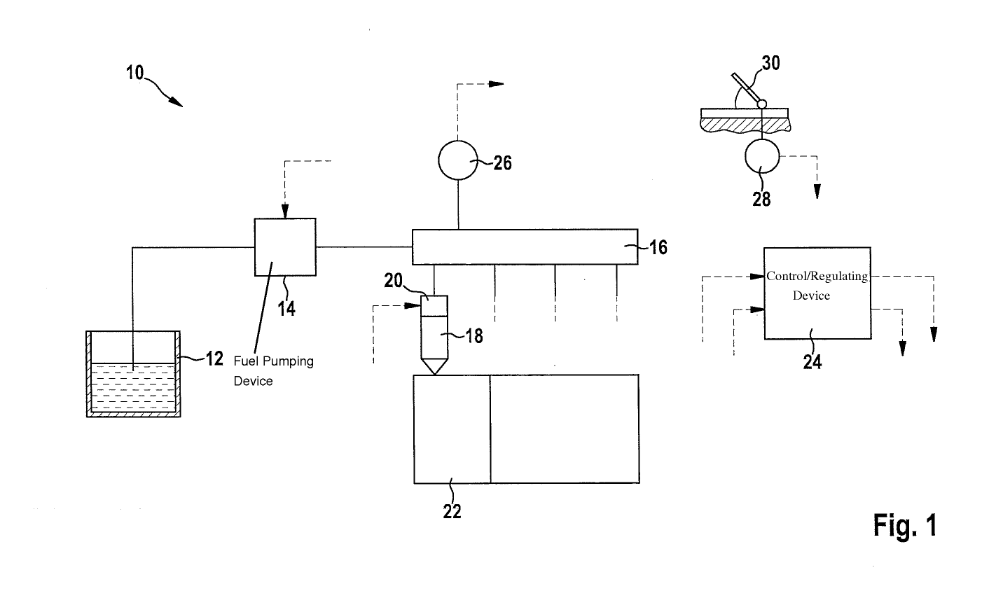

In FIG. 1, an internal combustion engine of a motor vehicle is denoted as a whole by reference numeral 10. It encompasses a fuel tank 12 out of which a fuel pumping device 14 pumps fuel under high pressure into a common rail 16. Fuel pumping device 14 may be an electrical presupply pump, for example, and include a mechanically driven high-pressure fuel pump having a quantity control valve.

Connected to common rail 16 are a plurality of fuel injectors 18, of which only one is shown in FIG. 1. Each fuel injector 18 has an electromagnetic actuating device 20 that moves a valve element (not shown) from a closed to an open position via an armature (not shown) in response to an actuation. In the case of fuel injector 18, it is a question in this respect of a solenoid valve. Fuel injector 18 injects the fuel directly into a combustion chamber 22 of internal combustion engine 10.

The quantity of fuel injected by fuel injector 18 into combustion chamber 22 is effected, on the one hand, by adjusting the fuel pressure prevailing in common rail 16 and, on the other hand, by adjusting the duration of the electrical activation of electromagnetic actuator 20. To this end, a control and regulating device 24 is used that receives signals from various sensors and outputs corresponding control signals. Control and regulating device 24 receives signals from a pressure sensor 26, for example, that records the fuel pressure prevailing in common rail 16. In addition, control and regulating device 24 receives signals from an accelerator pedal sensor 28 that conveys the desired torque input by a user by a corresponding depression of an accelerator pedal 30. On the one hand, control and regulating device 24 activates electromagnetic actuating device 20 of fuel injector 18 and, on the other hand, fuel pumping device 14, for example, a quantity control valve present there.

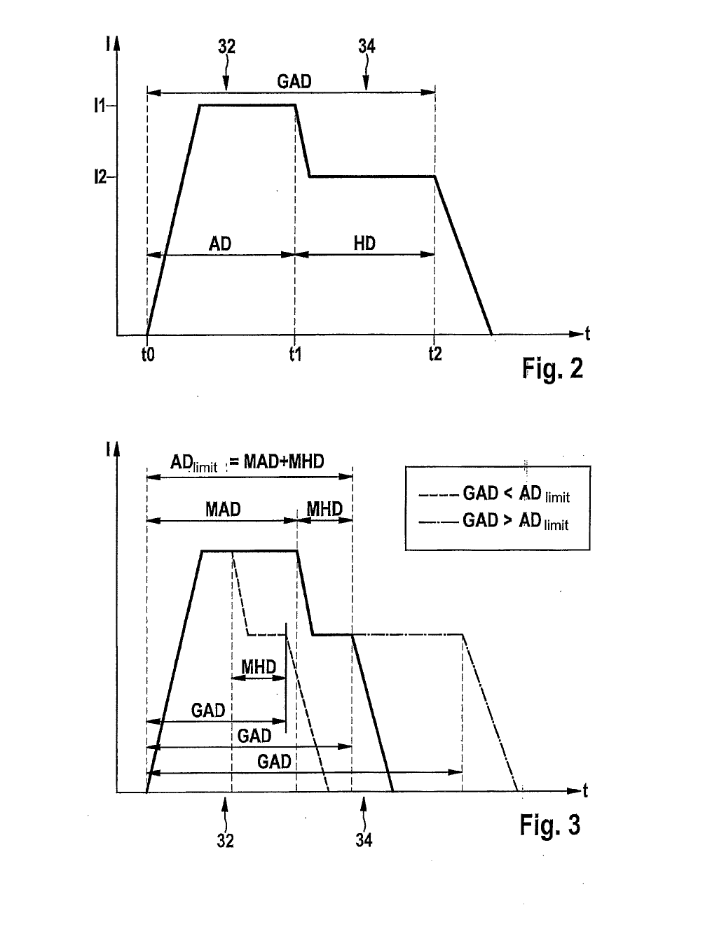

A typical activation signal (current 1) for an individual process for injecting fuel is plotted in FIG. 2 over a time t. The energization begins at point in time t0. A pickup current I1 is approached via an ascending flank. At a point in time t1, current 1 is lowered to a level I2. At a point in time t2, the energization is ended via the descending flank. The phase between points in time t0 and t1 is referred to as pickup phase 32, since it induces an armature (not shown) of electromagnetic actuating device 20 to be picked up at a high speed. The duration of pick-up phase 32 is also referred to as pick-up current duration AD. The time period between t1 and t2 is referred to as holding phase 34. The duration thereof is also referred to as holding current duration HD. Holding phase 34 is used for holding fuel injector 18 open using the least possible energy. The nominal total activation duration is denoted by GAD in FIG. 2.

As may be inferred from FIG. 3, a maximally permissible pickup current duration MAD is defined for pickup phase 32, whereas a minimally permissible holding current duration MHD is defined for holding phase 34. If total nominal activation duration GAD is shorter than the sum of maximally permissible pickup current duration MAD and minimally permissible holding current duration MHD (broken-line curve in FIG. 3), pick-up current duration AD is then modified to achieve desired nominal total duration GAD of the activation signal, while holding current duration HD retains defined minimally permissible value MHD. As explained further below, the minimally permissible duration of holding current 1 is variable in this present case, namely as a function of nominal total duration GAD of the activation signal. If, on the other hand, desired nominal total duration GAD of the activation signal is greater than the sum of maximally permissible pickup current duration MAD and minimally permissible holding current MHD, holding current duration HD is modified (prolonged) to achieve desired nominal total duration GAD of the activation signal, whereas pickup current duration AD constantly retains defined maximally permissible value MAD thereof (dot-dash line curve in FIG. 3).

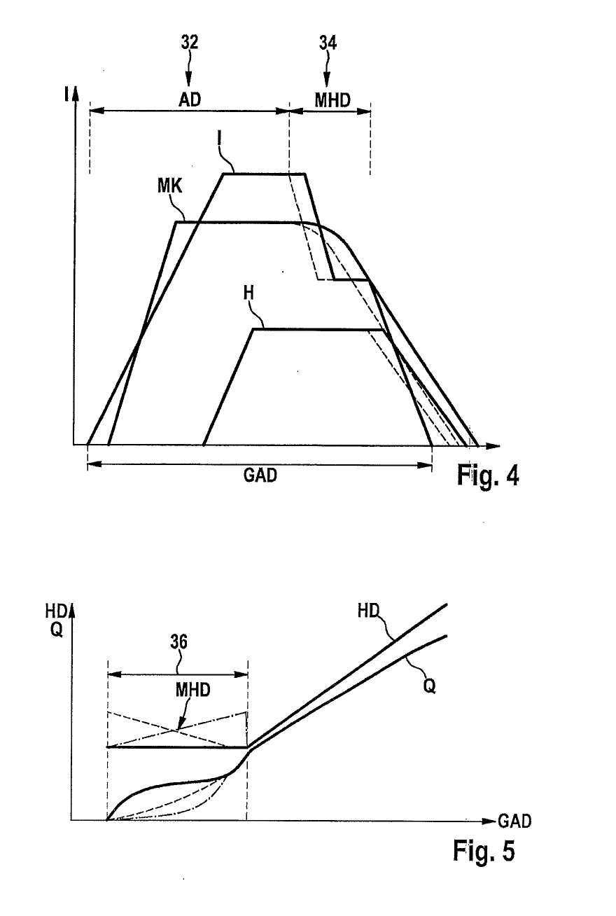

As already mentioned, in the case of such operating phases in which minimally permissible duration MHD of holding phase 34 comes into play (“MHD active”), the minimally permissible duration MHD of holding phase 34 is made dependent on nominal total duration GAD of the activation signal. In the case of a comparatively short, desired nominal total duration GAD, minimally permissible duration MHD of holding phase 34 is longer than in the case of a comparatively long nominal total duration GAD. This is described with reference to FIG. 4: There, a conventional control signal is plotted as a solid line in the case of a comparatively short, nominal total duration GAD of activation signal I, whereas the characteristic curve of excitation signal 1 is plotted as a dotted line in the case of internal combustion engine 10 shown in FIG. 1. In the present case, it is discernible that minimally permissible duration MHD of holding phase 34 is prolonged in comparison to a conventional internal combustion engine which, in order to lead to a same nominal total duration GAD, necessarily results in a shortening of pickup current duration AD of pickup phase 32. This leads to an earlier drop in the solenoid force (curve MK in FIG. 4) and thus to an earlier closing of fuel injector 18 (curve H for the stroke of the armature (not shown) of electromagnetic actuating device 20). Fundamentally conceivable, but not shown, however, is also a realization in the opposite direction: When it is to be expected that less than the desired fuel quantity is injected, minimally permissible duration MHD may be reduced. This results in an increase in solenoid force MK, thus to a later closing of fuel injector 18 and, in the final analysis, to an increase in the injected fuel quantity.

The dependence of minimally permissible duration MHD of holding phase 34 on nominal total duration GAD of the activation signal is readily discernible in FIG. 5. There, duration HD of holding phase 34 is plotted over nominal total duration GAD of the activation signal.

Likewise plotted in FIG. 5 over nominal total duration GAD of the activation signal is fuel quantity Q injected by fuel injector 18. Shown as a solid line, in turn, is the conventional case where the dependence in question is not present; shown in a dotted line in the present case of internal combustion engine 10, where, when minimally permissible duration MHD is active (the range in which minimally permissible duration MHD is active for holding phase 34, is denoted by 36 in FIG. 5), this minimally permissible duration MHD of holding phase 34 is linearly dependent on nominal total duration GAD of the activation (the left portion of curve HD in FIG. 5). It is discernible that this leads to a distinct evening out of the dependence of injected fuel quantity Q on nominal total duration GAD of the activation signal, in particular, in the case of small fuel quantities Q to be injected and corresponding nominal total durations GAD.

An alternative is likewise drawn in FIG. 5, namely by dot-dash lines: In this case, the relation between minimally permissible duration MHD of holding phase 34 is, in fact, likewise linear, but with a reverse slope and a step change at the end of range 36. This leads to the dependence (likewise illustrated in FIG. 5) of injected fuel quantity Q on nominal total duration GAD of the activation signal that is characterized by an inverse waviness relative to the initial state.

1-7. (canceled)

8. A method for activating a solenoid valve, comprising:
providing an activation signal having a pickup phase and a holding phase, wherein:
the pickup phase has a comparatively high current and a maximally permissible duration,
the holding phase has a comparatively low current and a minimally permissible duration, and
the minimally permissible duration of the holding phase is at least periodically dependent on a nominal total duration of the activation signal.

9. The method as recited in claim 8, wherein the solenoid valve is for a fuel injector of an internal combustion engine.

10. The method as recited in claim 8, wherein the minimally permissible duration of the holding phase is longer in the case of a comparatively short nominal total duration than in the case of a comparatively long nominal total duration.

11. The method as recited in claim 8, wherein the minimally permissible duration of the holding phase is shorter in the case of a comparatively short nominal total duration than in the case of a comparatively long nominal total duration.

12. The method as recited in claim 8, wherein the minimally permissible duration of the holding phase is only dependent on a nominal total duration of the activation signal when the nominal total duration of the activation signal is at least also composed of the minimally permissible duration of the holding phase.

13. The method as recited in claim 8, wherein a dependence between the minimally permissible duration of the holding phase and the nominal total duration of the activation signal is linear.

14. A computer program, programmed for implementing a method for activating a solenoid valve, comprising:
providing an activation signal having a pickup phase and a holding phase, wherein:
the pickup phase has a comparatively high current and a maximally permissible duration,
the holding phase has a comparatively low current and a minimally permissible duration, and
the minimally permissible duration of the holding phase is at least periodically dependent on a nominal total duration of the activation signal.

15. A control and/or a regulating device for an internal combustion engine, wherein a computer program is executable thereon, the computer program being programmed for implementing a method for activating a solenoid valve, comprising:
providing an activation signal having a pickup phase and a holding phase, wherein:
the pickup phase has a comparatively high current and a maximally permissible duration,
the holding phase has a comparatively low current and a minimally permissible duration, and
the minimally permissible duration of the holding phase is at least periodically dependent on a nominal total duration of the activation signal.
